(19) United States
(12) Patent Application Publication
(10) Pub. No.: US 2006/0219094 A1
(43) Pub. Date: Oct. 5, 2006

(54) Real time dynamically controled elevation and azimuth gun pod mounted on a fixed wing aerial combat vehicle

(76) Inventor: Nir Padan, Moshav Sade Yitzhak (IL)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/534,169

(22) PCT Filed: May 15, 2003
(86) PCT No.: PCT/IL03/00395

§ 371 Date: Apr. 3, 2006

(30) Foreign Application Priority Data
Nov. 6, 2002 (IL) 152680

(51) Int. Cl. F41A 23/00

(52) U.S. Cl. 89/37.16

(57) ABSTRACT

A gun pod, mounted on a fixed-wing aerial vehicle, stores, delivers, controls and supports a controllable movement gun unit. The gun pod includes a flexible gun mount, gun movement actuators, gun movement controllers, a standalone range finder, a standalone processor, and standalone sensors for capturing dynamically environmental data and for controlling the movement of the gun unit. The gun is provided with allowable ranges of movement in the elevation and the azimuth where the ranges are determined in accordance with the flight envelope of the aerial vehicle, the characteristics of the gun unit and the mounting location of the gun pod. The movement of the gun is either controlled manually or automatically.

### BACKGROUND OF THE INVENTION

1. Field of the Invention

The present invention generally relates to gun pods carried and utilized in aerial combat by fixed-wing military aerial vehicles. More particularly the present invention relates to gun pods, having the capability of controlling dynamically the elevation and the azimuth of an incorporated gun while being mounted on a fixed-wing aerial combat vehicle.

2. Discussion of the Related Art

Although presently modern military combat aircraft are typically equipped with diverse highly sophisticated advanced weaponry, such as guided missiles and precision-guided bombs, aerial gun systems are still widely used as an important component of an aircraft's weapon configuration both for Air-to-Air (A/A) and for Air-to-Ground (A/G) operations. Gun systems are versatile, reliable, lethal and low cost solution. Thus, the majority of fixed-wing military combat aircraft and attack helicopters are provided with the option of carrying gun systems. During the 1960's it was estimated that aerial guns are obsolete and therefore the weapon systems of fighter aircraft should be exclusively rocket and missile-based. During this period many fighter aircraft were not equipped with guns at all. Thus, for example, early versions of the F-4 Phantom tactical fighter and the AV-8B Harrier attack aircraft were originally fielded without a gun system but after extensive combat experience it was realized that a gun was still a crucial component in the overall weapon system of a combat aircraft while some of the more advanced weapons had specific limitations. Subsequently the F-4 Phantoms, the AV-8B Harriers and other aircraft were respectively retrofitted with advanced high-caliber guns having a high rate of fire. Since then typical combat aircraft are regularly designed and developed such that one or more internally integrated or externally mounted gun is provided. Gun systems carried by combat aircraft survives in this age of sophisticated Beyond Visual Range (BVR) missiles, IR missiles and precision-guided munitions, as vital weaponry elements of aerial combat due to the several advantages they offer. Guns are typically installed internally in a forward firing position, such that they are stationary relative to the fuselage of the aircraft. As a result less drag is produced and the impact on the performance of the aircraft is slight. Consequent to the ever accelerating technological progress aerial guns are becoming rapidly more effective. Recently, advanced features were added to the gun systems, such as an improved cyclic rate providing an increase of fire power, the introduction of new PGU-like projectiles that provide for accurate and efficient armor piercing firing for up to two times of the previous firing operating distances, and diverse advanced operating options, such as the provision of dynamic in-flight selection of the ammunition type, the selection of the burst length, gas management to reduce thermal signature, compact ammunition storage and the like. Guns are versatile in the sense that they could be used both for A/A and A/G. Guns (although not gun control systems) are also insensitive to modern electronic countermeasures. Along the advantages offered presently available aerial guns have a number of serious drawbacks when comparison is made between the guns and the advanced A/A and A/G missiles and bombs.

Guided bombs and missiles provide substantial operational flexibility due to various autonomous pre or post launch capabilities systems that provide for the off bore sight wide azimuth range of locking, tracking, guidance of the targets, to their capability of being launched to targets off the bore sight and to the capability of independent post-launch operation.

Modern combat aircraft, having advanced maneuvering capabilities, typically perform close-range A/A engagements (also called dog fights) within the gun system's operating envelope that is typically more restricted than that of the missile system envelopes. Current gun systems are substantially limited as a result of the requirements concerning precise locking on the target and precise maneuvering of the aircraft within the limited gun envelope. Furthermore, the projectiles fired by a gun do not have a limited guidance capability. Thus, the pilot need relatively significant amount of time and aircraft resources to obtain effective gun offensive position Gun systems also require, precise control of the flight passes and a high gain gun aim point-tracking control, in both A/A and A/G. Due to the above reasons even experienced pilots achieve only a limited percentage of successful gunnery attacks. A further disadvantage of the gun systems is that the use of the gun during aerial combat endangers the aircraft crew due to the fact that when effectively firing a gun the aircraft should be in close proximity to the target. The pilot must continue flying in the target's direction during the aiming and the firing of the gun and at times performing slow flight patterns. These patterns endanger the aircraft during low assault ground attacks. In addition, getting into a close proximity of a target during a mission in order to achieve effective gun firing ranges affects high combat dynamics and increases the probability of being hit by hostile fire. An unsuccessful gun attack pass further increases the vulnerability of the aircraft during the repeated attack passes consequent to the alert provided by the first pass to the target. Although the firing range and the theoretical capabilities of destroying viable targets during both A/A and A/G missions has increased following the introduction of the new PGU-like projectiles, the practical capabilities of hitting aerial and ground targets has only slightly risen due to the described limited capabilities. Thus, the use of present guns installed on fixed-wing military aircraft requires the execution of precise flight control passes and high gain tracking control. Consequently, excessive pilot workload is generated that could dramatically degrade the pilot's situational awareness (SA). The aerial gunnery-related disadvantages impact the design of new aerial vehicles as well as the ongoing upgrade efforts for existing aerial platforms and weapon systems. The emerging solutions indicate opposing trends, such as the complete dropping of the internally integrated gun systems from the aircraft weapon configuration, such as in the case of the EF-2000 Eurofighter Typhoon and the F-35 Joint Strike Fighter, and at the same time the alternative provision of one or more optional external weapon configurations that include externally mounted gun pods, such as in the case of the F-35 Joint Strike Fighter. Simultaneously, the existing gun pods to be uploaded as external weapon stores on aircraft are undergoing considerable upgrades in the attempt to improve the operation of and to enhance the options of the system by the introduction of advanced features and more sophisticated gun control and gun aiming sub-systems.

Gun pods for enveloping and packaging externally mounted guns were introduced in order to allow the carriage of high-caliber guns and enhanced volume ammunition magazines for the storage of a sufficient quantity of rounds, to streamline the gun system design and for increasing the aerodynamic efficiency of the vehicle. Detachable externally mounted gun pods further provide for flexible weapon pairing, and ready accessibility for loading, and maintenance. Thus the gun pod in its present form is a typically detachable, externally mounted, aerodynamically shaped container incorporating an integrated gun system comprising one or more aerial guns having diverse calibers, one or more ammunition magazines and associated ammunition feed system. The aerodynamic shape provides for optimal flight characteristics required. A typical gun pod is equipped with pylon adapters that enable rigid mounting on a hard point in order to accomplish firing-point accuracy and repeatability. Gun pods are also including a suitable electronic control sub-system, which interfaces to the weapon stores control system of the aircraft.

In the traditional gun pods located on a fixed-wing aerial combat vehicle the gun is fixedly mounted, requiring the pilot to maneuver and aim the whole aircraft in order to track a target. Although sophisticated military-off-the-shelf components, such as enhanced radar systems covering sectors of up to about 60 degrees (a complete spherical sector could be covered in the future), high-speed data links and the like, provide increased target acquisition flexibility and, enhanced firing solutions, the elevation and the azimuth control of the gun (substantially independently of the vehicle's attitude) is requisite to the actual pointing of the gun to the acquired target.

Lately the diverse weapon systems mounted on fixed-wing military vehicles becoming increasingly more accurate following the incorporation of an advanced inertial or GPS system, and the slaving of these weapon systems to various tracking sensor devices, such as radar, IR, FLIR and the like. Consequently modern weapons are becoming more precise and less dependent on the manual manipulation of the pilot. Presently gun systems on fixed-wing aerial vehicles are not provided with the option of being slaved to sensors.

Although combat aircraft weapon systems usually include target acquisition, target locking, and target tracking various capabilities, in association with computing and display devices, the guns themselves are typically rigidly mounted without the option of re-positioning the gun's firing line during the flight. Controlled positioning of the guns across a substantial range of movement as practiced in attack helicopters is not typically implemented in fixed-wing combat aircraft due to reasons of aerodynamic efficiency. Guns are typically mounted in a gun pod in such a manner that the barrels of the guns protrude from a suitably located aperture of the gun pod into the air stream. Since gun barrels have aerodynamically inefficient profiles the effects of steering the guns cause increased drag, reduced stability and control. These effects are specifically critical at the high-speed/angle of attack maneuvers typically performed by fixed-wing aerial combat vehicles during combat. Although it is imperative that prior to the operational introduction of a gun system suitable flight testing procedures to be performed in order to establish an optimal flight envelope associated with the carriage and the firing of fixed guns by the aircraft, the continuous movement of a controllably positioned gun barrel relative to the direction of the air stream and the subsequent firing of the gun at an angle deflected from the directional or vertical axis of the vehicle could substantially modify the optimal flight envelope via the generation of increasingly negative aerodynamic effects, such as high drag, severe instability and reduced handling capability.

It would be readily perceived by one with ordinary skills in the art that a novel system and method is needed in order to provide comprehensive, precise, cost effective and efficient solutions to overcome the disadvantages regarding the utilization of aerial gun systems mounted on high-speed fixed-wing aerial combat vehicles performing aerodynamically demanding operational activities, such as A/G and A/A attacks involve, yet with minor aerodynamic degradation.

### SUMMARY OF THE PRESENT INVENTION

The present invention provides for a system and method of substantially automatic real-time slaving and positioning of a wide-angle aerial gun towards the target within a maximum allowable deflection capacity that is either fixed deflection pre-defined limited, or by a fire control system allows changing deflection variant limit as a function of pod type, carrier aircraft, weapon station that carry the pod, airspeed, angle of attack ext., suitable for a rapidly changing environment with minimum degradation of the aerodynamic efficiency and the stability of then aircraft.

One aspect of the present invention regards an apparatus for dynamically controlling the elevation and azimuth of an aerial gun unit incorporated within a gun pod unit mountable on a fixed-wing aerial combat vehicle. The apparatus comprises the following elements: an aerodynamically efficient gun pod unit for storing, delivering, controlling and supporting a controllable movement aerial gun unit, and a controllable movement aerial gun unit mounted in the aerodynamically efficient gun pod unit and designed for the delivery of suitable gun projectile units to a ground-based or aerial target. The dynamic deflection control limits of the aerial gun of may be accomplished in real time, taking into account the optimal desire of the pilot or system to fire and hit the target based on the various information available including such as the ordinances carried at any given time by the aircraft, the used weapons stations, the angle of attack, the stress placed on the aircraft in flight, the location of the aircraft within the flight envelope, the stability of the aircraft prior the requested fire, and also the possibility of actually hitting the target and such like or similar considerations. The gun may have a limited deflection predetermined irrespective of the type of aircraft or weapon station used. The gun may have a deflection relative to the various information available to the gun control including but not limited to the ordinances carried at any given time by the aircraft, the used weapons stations, the angle of attack, the stress placed on the aircraft in flight, the location of the aircraft within the flight envelope, the stability of the aircraft prior the requested fire, and also the possibility of actually hitting the target and such like or similar considerations. Furthermore, the gun may have a deflection according to real time limitation such as when the gun is used by an aircraft having limited envelope or instruments, which will allow the full use of the gun's capabilities.

A second aspect of the present invention regards a method for dynamically controlling the elevation and azimuth of an aerial gun unit incorporated within a gun pod unit mountable on a fixed-wing aerial combat vehicle. The method comprises of the following steps: modifying the strength, diameter and volume of the gun pod unit to allow for the incorporation of the gun unit and gun movement support components, extending the diameter of the gun pod aperture to enable the allowable ranges of movement in the elevation and the azimuth for the barrels associated with the gun unit and installing an aerodynamic flexible covering on the gun pod aperture to provide for efficient air flow in the vicinity of the gun pod unit.

A third aspect of the present invention regards an apparatus for dynamically controlling the elevation and azimuth of an aerial gun incorporated within a gun pod mountable on a fixed-wing aerial combat vehicle. The apparatus comprises the following elements; an onboard fire control computer to store gun movement control data, to receive sensor data, or to receive remote data, to use software that calculate and generate gun movement allows efficient A/A, A/G target aiming, to communicate with the vehicle's operating crew and to communicate with the aerodynamically efficient gun pod, at least one onboard sensor device to collect relevant environmental information and to transmit the information to the fire control computer, at least one onboard communication device to communicate with remote information sources (OK—its not a limitation only an addition) and to transmit received information to the fire control computer, at least one an aerodynamically efficient gun pod unit for storing, delivering, controlling and supporting at least one controllable elevation and azimuth movement aerial gun unit and at least one controllable movement aerial gun unit mounted in the at least one aerodynamically efficient gun pod unit for the delivery of suitable gun projectile units to a ground-based or aerial target.

### BRIEF DESCRIPTION OF THE DRAWINGS

The present invention will be understood and appreciated more fully from the following detailed description taken in conjunction with the drawings in which:

FIG. 1A demonstrates the use of a fixed mounted gun installed in an aircraft while performing an A/G attack, as known in the art;

FIG. 1B demonstrates the use of a controllable movement gun mounted in a gun pod by an aircraft when performing an A/G attack, on accordance with a preferred embodiment of the present invention;

FIG. 2A demonstrates the use of a fixedly mounted gun installed in an aircraft when performing an A/A attack, as known in the art;

FIG. 2B demonstrates the use of a controllable movement gun mounted in a gun pod by an aircraft when performing an A/A attack, on accordance with a preferred embodiment of the present invention;

FIG. 3 shows an exemplary system environment in which the controllable movement gun mounted within a gun pod operates, in accordance with a preferred embodiment of the present invention.

FIG. 4 shows a schematic simplified side view of a gun pod that incorporates a controllable movement gun, in accordance with the preferred embodiment of the present invention

### DETAILED DESCRIPTION OF THE PREFERRED EMBODIMENT

The present invention discloses a novel gun pod to be mounted and integrated on a fixed-wing aerial combat vehicle. The present invention also discloses an apparatus and method for dynamic controlling of the elevation and azimuth of a wide-angle gun integrated into a gun pod mountable on a fixed-wing aerial combat vehicle. The gun pod includes one or more guns, standard gun support components, such as an ammunition magazine; ammunition feed sub-system, a monitoring sub-system, and a firing control sub-system. The gun is provided with the capability of movement across a range of deflection degrees relative to the axes of the aircraft. The gun mounted in the pod may be controlled and moved longitudinally and attitudinally (covers both). The pod is designed to allow such movement while the gun muzzle can is partially covered to allow better aerodynamic shape to the pod thus allowing the plane to maintain envelope limitations when flying at various speeds angles of attack. The aerodynamic impact to the plane is likely to be slight and is greatly dependant on the location of the plane within the flight envelope. The gun can be gas-operated 27 mm or a 30 mm revolving or non-revolving cannon having rates of about 1500-1800 rounds per minute. The gun is mounted within the pod and attached to motor servos allowing longitude and attitude movement as instructed by the gun control system. The gun is fed automatically with appropriate projectiles through an automatic projectile feeding system. The gun's movement within the gun pod is controlled either manually by the pilot or by the systems operator of the aircraft or preferably by automatically slaving, via the Fire Control Computer (FCC), to a various target tracking sensor devices, such as radar, Infra Red (IR), Data Link (DL), Head mounted sight (HMS) and the like, subsequent to the slaving of the gun to the target tracking sensor device via a specifically developed gun slaving and gun movement control system. The slaving of the gun could be initiated either in an automatic or a manual manner.

The gun positioning control system includes a specific configuration of functionally interconnected hardware and software components. The configuration of the control system may depend on the original configuration of the carrier aircraft and the specific characteristics of the controllably positioned gun installed in a gun pod. The gun movement and positioning may also depend on limitations set by the flight envelope limitation. Thus, for example when flying above 500 KIA the gun movement may be restricted to several degrees where as in flight at a speed less then 250 KIA for example the gun movement may be restricted to 10-15 degrees. The dynamic deflection control limits of the aerial gun of may be accomplished in advanced, or in real time, taking into account the optimal desire of the pilot or system to fire and hit the target based on the various information available including such as the ordinances carried at any given time by the aircraft, the used weapons stations, the angle of attack, the stress placed on the aircraft in flight, the location of the aircraft within the flight envelope, the stability of the aircraft prior the requested fire, and also the possibility of actually hitting the target and such like or similar considerations. The consideration relating to the actual possibility of hitting the target may also be linked to the cost of performing each of the fire sequences. Thus, for example, if the possibility of hitting the target is negligible and the costs of the requested-fire sequence is significant, the system of the present invention may determine to not allow the performance of the firing sequence. The gun may have a limited deflection predetermined irrespective of the type of aircraft or weapon station used. The gun may have a deflection relative to the various information available to the gun control including but not limited to the ordinances carried at any given time by the aircraft, the used weapons stations, the angle of attack, the stress placed on the aircraft in flight, the location of the aircraft within the flight envelope, the stability of the aircraft prior the requested fire, and also the possibility of actually hitting the target and such like or similar considerations. Furthermore, the gun may have a deflection according to real time limitation such as when the gun is used by an aircraft having limited envelope or instruments, which will allow the full use of the gun's capabilities.

The limitations are programmed into the gun's hardware and software components. In some planes such components will be located in the planes themselves. However, in legacy aircraft the hardware and software may be a part of the gun pod and only an interface will be required to be implemented as per the particular aircraft's existing avionics.

Thus, where specific components necessary for the operation of the system are already installed in the aircraft then these components could be utilized as operative elements of the gun movement system. When the gun pod including the controllably positioned gun is mounted on an aircraft that does not have one or more of the necessary gun movement control-related components then the components could be supplied within the gun pod. For example, the continuous measurement of the range between the gun and the target is provisional to the effective firing of the gun. A range measurement device, such as a laser device, installed in the gun pod could provide the necessary information in the case when the aircraft does not have this capability either temporarily as a result of malfunctioning equipment or semi-permanently as a result of non-installed equipment. Note should be taken that while the range measurement device points to the target the barrel of the gun is pointing at an advance/lead angle. The controlling of the elevation and azimuth of the gun within the gun pod is accomplished by the controlled positioning of the gun in respect to the axes of the aircraft while the pod itself remains substantially stationary.

In order to enhance the avionics, or the information processing, or DSP capabilities of an aerial vehicle additional components could be installed in the gun pod such as a GPS device, an inertial guidance system, a D.L. system allowing gun slave to outsource target tracking sensor, an enhanced fire control computer and the like. These in-pod components could replace or suitably supplement existing on-board components or could allow for the operation of the proposed system and method on aerial platforms lacking one or more of the necessary units.

The gun operates in the following manner: a gun firing instruction is received from the pilot or the weapons operator. The gun barrel aiming point is calculated and performed dynamically in response to control signals fed continuously to the hydraulically and electrically actuated motors following either appropriate manipulations of suitable control components of the gun control panel/HOTAS by a pilot or consequent to the results of specifically defined calculating formulas operating on real time.

The software and hardware components employ control data relating to the gun's known operating characteristics, such as caliber, recoil power, rate of fire, type of projectiles, number of stored rounds and the like is also stored on the memory device on the on-board microprocessor. The software further includes a set of known formulas for ballistic calculations enhanced with algorithms regarding the issue of firing a gun where the barrel is oriented in an angle different from the flight path angle.

The sensory data received from appropriate sensors in association with pre-determined static data regarding the flight envelope of the aircraft, the gun's operating characteristics, and the like. The pre-determined static control data is stored in a memory device of an on-board fire control computer or an in-pod microprocessor in accordance with known aerodynamic data specific to the aircraft, with test flight data generated during design overviews, ground tests and flight tests with the gun pod under conditions substantially similar to the environmental conditions prevalent during the performance of the gun deflections at various air speeds, altitudes, angle of attack and the like.

Additional algorithms/software functions could be designed to deflect the gun within pre-defined or dynamically calculated positioning limits. During the performance of a mission such as an A/G engagement, for example a suppression of enemy defenses (SEAD) or an A/A engagement such as a DGFT, when the gun system becomes operative, the operation of the gun movement control system utilizes the static pre-determined stored data and it is further fed with real-time data collected by specific airborne sensor devices. Thus, the speed of the aircraft is determined dynamically by utilizing specific air speed measuring devices. The values of the G-force, the slide-slip, the Mach number, and the angle-of-attack as well as the attitude of the aircraft is captured by appropriate measuring devices such as gyroscopic sensors, accelerometers, and the like.

Responding to the transmission of suitable control signals from the on-board avionics of the aircraft, a set of actuator devices such as hydraulically or electrically activated motors impart a specific combined movement in one or two axes on moveable gun mounts fixed on one hand to the body of the pod on which the gun is mounted in the desired direction either directionally or vertically or in any combination thereof where the control signals generate a combined movement in one or two axes. Following the deflection of the gun mount the gun is moved to a desired direction and the gun barrel's aiming point is re-positioned accordingly.

For the effective carrying out of the mission that involves engaging a ground or an aerial target relevant target-specific data should be collected as well. Such data is normally available through on-board existing systems, which provide various types of information about the plane and about the targets surrounding the plane and the environment. Thus, the speed (if applicable) and range of the target could be detected by a radar device, a laser range finder device, an infrared device, or the like and stored by the on-board computer.

Where the identity of the engaged target is unknown before the attack, subsequent the identification of the target (either by the pilot or weapons operator of the aircraft or by an airborne command and control platform) appropriate flight envelope and weapon performance related target data could be accessed in a target characteristics database. The real-time or static data regarding the target could be transmitted via a suitable high-speed wideband communication link direct to the appropriate storage of the aircraft in order to assist the gun positioning control system in the fire control solution.

The gun pod software and hardware make use of the available data present and offered on the plane hardware bus. When a target is acquired the software of the gun pod receives such information that is available to all other systems. Automatically following the suitable indication of the locking of the target. The fire control computer executes a specific set of software instructions operative in the performance of the calculations concerning the slaving of the gun to the suitable angle. An optional set of software instructions may be used to calculate the maximum allowable dynamic limits of the gun deflection. If the calculated angle is outside the maximum allowable deflection limits the pilot is suitably notified. The pilot may or may not, depending on his own judgment, decide to direct the plane so that the deflection point is within the limitation set by the gun pod software allowing the gun to fire and the target to be positioned appropriately.

The control system processes the plurality of real-time data continuously and successively in accordance with the rapid changes in the environment affected by the maneuvering of both the aircraft and the target and determines the lead aiming line of the barrel to the expected movement of the target and to other relevant data. According to the results of the processing the barrel of the gun within the gun pod is deflected in a suitable combination of the deflection axes.

During the engagement the gun movement control system continuously attempts to aim at the target by a) re-positioning the barrel of the gun and b) the software of the gun introduces to the pilot or weapons operator the scope in which the pilot may maneuver and still be able to hit the target when the gun fires. It may also provide the pilot with the angle necessary to steer the plane to a position where the gun will hit the target or if the target is outside the envelope to be sustained for a hit to be made. The pilot may maneuver the aircraft to allow the nose of the aircraft to be within an effective and the horizontal/vertical angle limit of allowable barrel deflection such as to put the aircraft in an advantageous position relative to the target and b) the gun movement control system dynamically re-positioning the gun barrel in such a manner as to keep the aiming point of the barrel on the target within the pre-defined positioning limits. When the range between the aircraft and the target is suitable for shooting the pilot will be suitably notified by the system in a manner similar to the manner of notification regarding the suitability of engaging A/A missiles. Consequently the firing mechanism of the gun may be activated by the pilot and firing may begin toward the target at a pilot-selected burst length (typically short). So for example, the gun pod software may notify the pilot at a distance of about 6 miles from the target that the target is within the gun pod sectional envelope and at about 3 miles the gun pod software authorizes to open fire. Opening fire may be accomplished according to predetermined states of automatically or manually.

The pilot may activate the firing mechanism of the gun and firing may begin toward the target at a pre-defined or a pilot-selected type of projectiles used and burst length (typically short). It may be predetermined before the flight begins or during the flight that the fire mechanism may be completely automatic and that once the software associated with the gun determines that a target may be hit it will automatically discharge projectiles so to attain best-hit results.

As long as the range of the gun position adjustment enables the aiming point of the gun to be on the successive points to which it is calculated that the projectiles of the gun will arrive simultaneously with the target the firing could continue as the gun is directed to the target.

At a specific point in the flight path the relative angle between the aircraft and the target is such that the gun is unable to track the target even at its most extreme elevation and/or azimuth vector. At this point the firing of the gun is automatically terminated and the attack is broken off. The attack may be resumed automatically once the elevation and/or azimuth vector and the allowed envelope data enable the gun to track the target efficiently so firing may relatively end in hitting the target.

If the aircraft does not carry suitable sensor devices, such as a radar (or A/S, AOA, ALT inertial system, GPS), the gun pod could be equipped with a distance measuring device such as laser system and the like, to be aligned with the target line of sight in order to provide the gun pod with the capability of generating distance measuring data. Thus the gun barrel could be guided simultaneously at an advanced/lead-shooting angle. Optionally the gun pod could be equipped with other standalone sensors and processing units where mounted on an aircraft that does not have the equivalent units installed or where no suitable real-time data transfer interface is installed between the weapon station and the aircraft.

The gun could under these circumstances be slaved to the in-pod sensors/processor/software. As a general rule the will be controlled and operated automatically. At extreme circumstances, such as the malfunctioning of the automatic control system, the pilot could make the positioning of the gun installed in the gun pod manually.

The static and dynamic real-time data could be entirely delivered from a remote data source such as an airborne command control platform, a ground-based or space-based command and control platform via a high-speed wide bandwidth data link.

The system and method proposed by the present invention offer several advantages over the prior art. One advantage regards a substantial increase in the number of potential shooting positions during A/A or A/G attacks. The gun pod and the associated gun movement control system negates the necessity of performing a gunnery attack in a in a straight line towards the target and thereby allows a plurality of additional shooting positions and enhanced firing sectors where it is estimated that the combined firing sections could be increased between about several degrees to about tens of degrees. The existing gun systems in fixed-wing aerial vehicles are utilized principally for the DGFT aft firing sectors in order to prevent collision when using forward firing sectors. The ability of substantially deflecting the line of fire of the gun from the line of flight provides a plurality of shooting positions from the forward firing sectors and thereby enhancing effectively operational envelope of the A/A gunnery attacks. As a result the effectiveness of the gun system is significantly enhanced.

Another advantage regards the increase of the survivability of the aircraft in both A/A, A/G missions. The aircraft is provided with an enhanced firing sector and an extended time window/aerial-positioning window in which effective shooting could be performed. The aircraft could select diverse attacking positions and various alternative attack paths and could keep a safer distance/altitude from the hostile target in order to avoid defensive response fire from the hostile target and from diverse anti-aircraft guns/missiles located within the target area.

Another advantage of the proposed system and method regards the enhanced capability of destroying A/G targets that are not readily penetrated such as ground-to-air (G/A) and ground-to-ground (G/G) missile installations, radar stations, heavy ground vehicles, enforced bunkers, strong points and the like. Currently when attacking such targets using a gun the approach to the target involves high risks related to low-level flying requirements and the need of placing the aircraft in close proximity to the target. The controllably positioned gun installed in a gun pod and the gun movement control system reduce these risks as the flexibility of the gun positioning negates substantially the need for low-level flying and to getting dangerously close to the target.

As a result enhanced capability of destroying several targets in a single attack is achieved. In contrast to “hard” targets”, gunnery attacks provide an efficient alternative to bombs, rockets and precision-guide munitions and are very effective against “soft” targets, which are the majority of targets in a battlefield. Attacking such targets with gun requires very precise flying combined with high survivability requirements. The proposed system and method negates the necessity for precise flying while provides enhanced survivability.

Another advantages of the propose system and method concern reduction of the pilot's workload due to the fact that the gun system becomes a guided weapon and thereby the enhancement of the situational awareness which in turn enhances the survivability of the aircraft.

Other advantages of the propose system and method include increased mission versatility (A/A, A/G), temporal versatility (day and night operations, all-weather capability) and the like.

The overall advantage of the proposed system and method concerns the provision of a substantially efficient low-cost, affordable and economical solution to the problems involved in the combat utilization of military aircraft when considering the cost of gun projectiles versus the cost of A/A missiles and A/G bombs.

In the preferred embodiment of the present invention the controllably positioned gun mounted in a gun pod is implemented by suitable modifications performed on an existing gun pod as known in the art. The modification involves typically the increase in the size of the pod, the strengthening of the structure of the pod, the insertion of the controllably positioned gun mounts, the suitable enlargement of the gun pod aperture in order to enable sufficient deflection of the gun barrel, the re-configuration of the internal components of the pod, the addition of appropriate gun mount actuators, hydraulic lines, electrical lines, suitable sensors, processors and the like. In other preferred embodiments the gun pod could be completely designed and developed as a novel unit. Preferably the gun pod would have a modular configuration where the components within and the internal arrangement thereof will be interchangeable. The modified or newly developed gun pod will have additional service panels for the maintenance of the new components. The gun pod will undergo a series of design tests, simulations, ground tests and flight tests (both for a symmetrical and an asymmetrical weapon configuration) to prove airworthiness and in order to collect flight envelope related data. Following the diverse tests the flight control computer of the aircraft or the standalone microprocessor of the gun pod itself should be updated with the relevant flight envelope data, gun behavior data, gun characteristics data and the like. The collected aircraft, gun performance and gun pod specific static data should be disseminated in a regular fashion to purposes of command and control across the appropriate platforms in the organization.

Although in the preferred embodiment of the present invention the representative aerial vehicle is a fixed-wing multi-role fighter aircraft, it would be easily understood that in other preferred embodiments various other military aerial vehicles could benefit from the advantageous features of the of the invention, such as various Unmanned Combat Aerial Vehicles (UCAVs), and a variety of existing and prospective aerial vehicles currently in design, development and testing stages. In addition to military aircraft police aerial vehicles, border patrol aircraft, and the like could benefit from the system and method of the proposed invention and light attack aircraft could utilize the system and method for counterinsurgency operations. Note should be taken that one or more gun pods could be uploaded on various weapon stations associated with a specific aircraft, such as under wing hard points, center fuselage hard points, internal weapon bay hard points and the like. One or more gun pods including one or more controllably positioned guns could be also installed internally within the body of an aerial vehicle. The following description of the preferred embodiment is exemplary only and is provided for the ready understanding of the invention. The description is not meant to be limiting in any way and the limits of the invention are defined only by the attached claims.

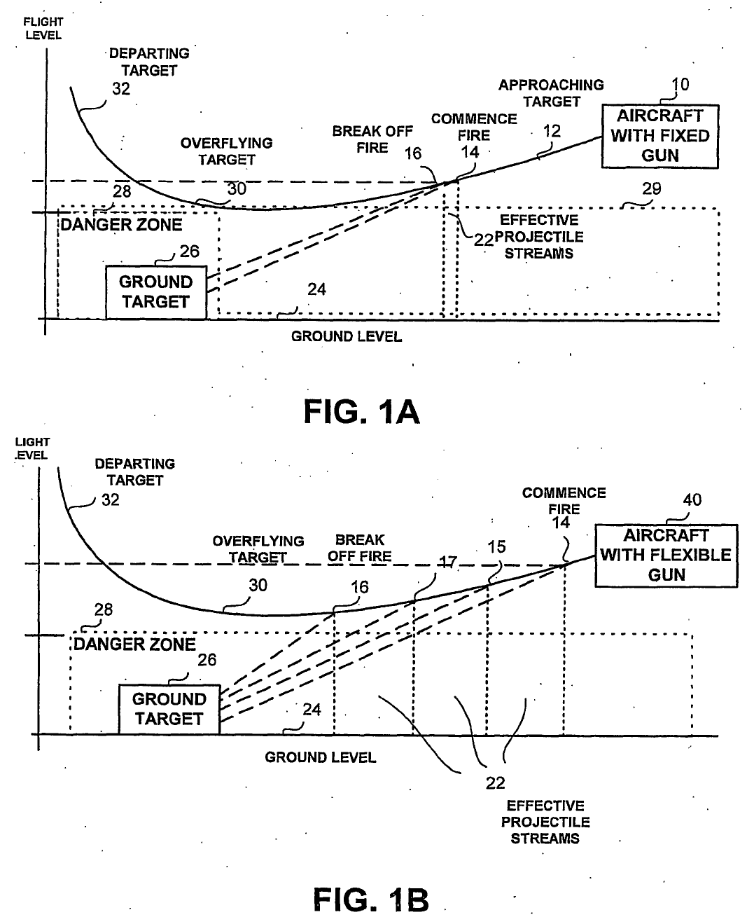

Referring to FIG. 1A that demonstrates an exemplary environment in which an attack aircraft 10 having a fixed gun system (not shown) is performing an A/G attack against a ground target 26. The aircraft 10 approaches the ground target 26 along a specific flight path. In accordance with the demands of the fixed gun system the aircraft 10 approaches the target 26 in a substantially straight line while the path is descending in the “approaching target” stage 12, ascending in the “over flying target” stage 30 and more steeply ascending in the “departing target” stage. 32. The angle of descent in the approaching target stage 12 is such that at point 14 the aiming line of the gun is converges with the target 26 and the range between the aircraft 10 and the target 26 is sufficient for the projectile stream delivered by the firing of the gun to reach the target 26 in such a manner as to hit it in an effective manner (including the corrections effected by the bore-sighting procedure associated with the gun and the associated gun sight, the automatic corrections made by an on-board fire control computer that takes into consideration the lead factor, the ballistic characteristics of the projectiles, the aircraft speed and the like). The acquisition of the target is made by the locking of the radar or FLIR on the target. The designation of the target to pilot is made by suitable indicators in the sighting device such as the HUD. Subsequently the measuring of the range and the relative angle between the aircraft and the target is performed continuously. Therefore at “commence fire” point 14 the fixed gun mounted-on the aircraft 10 is activated and a stream of projectiles is fired at the target 26. The firing of the fixed gun continues until the “break off fire” point 16 on the flight path is reached. At point 16 the aircraft 10 begins to, ascend in order to initiate the “overflying target” stage 30. The change in the flight path is affected in order to avoid getting too close to the target 26 such as not to risk entering the danger zone 28 around the target 26. The zone 28 is dangerous to fly in due to the potential anti-aircraft fire at the location of the target 26. When the “overflying target” stage 16 is initiated the relative angle between the flight path of the aircraft 10 and the target is modified and as a result the fixed gun aiming line is now above the target 26. Consequently at point 16 the firing of the gun is terminated and the aircraft 10 overflies the target 30 and departs the target 32 while avoiding the danger zone 28. The danger zone is not limited to flak fire arriving from the target area but also from other location, such as area 29. This means that the aircraft is safer at flying above a minimum flight level 29. Therefore an aircraft equipped with the system and gun of the present invention is able to perform firing at a target in range of about 0.5-2 miles without flying lower than is absolutely necessary. The gun may directed towards the target enabling the pilot better odds while making the attack run and over flying the target and finishing the attack run. The drawing demonstrates clearly that the only flight path segment during which the firing line of the barrel of the fixed gun is suitably aligned with the target 26 is the “effective projectile stream” segment 22 above the minimum flight level 29.

Although the sizes of the objects, the altitudes, and the distances shown in the drawing are not according to scale, it should be noted that the attacking aircraft 10 must follow a substantially predictable flight path effecting a substantially limited firing sector and have a substantially limited period of time in which to align the firing line of the barrel of the fixed gun with the target 26. During the attack the aircraft 10 has to fly in a straight line and descend dangerously low to provide for a period of time long enough to send a reasonably sized projectile stream to the target 26 in order to achieve an effective hit thereon. The above precise flying exigencies endanger the aircraft 10 to anti-aircraft fire and put a considerable stress on the attacking pilot.

Referring to FIG. 1B that demonstrates an exemplary environment in which an attack aircraft 40 having a flexible (controllably positioned) gun system (not shown) is performing an A/G attack against a ground target 26, in accordance with the preferred embodiment of the present invention. The aircraft 40 approaches the ground target 26 along a specific flight path. As the aircraft 40 is equipped with controllably positioned gun system it is not necessary for the aircraft 40 to approach the target 26 in a substantially straight line but in order to emphasize the difference between the use of fixed gun and the use of an adjustable gun the drawing under discussion shows aircraft 40 approaching the target 26 in a straight line. The controllably positioned gun has a capacity to be re-positioned either manually or preferably automatically relative to the axes of the aircraft 40 and the aiming line of the gun barrel indicated in the gun sight converges with the outline of the target 26 according to the changing position of the gun at the “commence fire” point 14 on the approach path is reached substantially earlier than the equivalent point 14 on the previous drawing FIG. 1A. As the aircraft proceeds along the approach path and successively passes point 15, and 17 the controllably positioned gun is respectively deflected in the elevation in order to keep the firing line of the barrel on the target 26 and to keep the barrel firing line indicator in the gun sight tracking the outline of the target 26. It should be noted that the aircraft 40 begins to ascend i.e. changes the angle of the flight path relative to the target 26 before reaching the “break off fire” stage 16. As a result of the capacity of the controllably positioned gun to be deflected in the elevation, the gun is pointed successively at points in space to which it is estimated that the target and the projectiles fired from the gun will arrive simultaneously even in the ascending segment of the approach path. Thus the gun may continue firing (at a pilot command or according to predetermined criteria) until the “break off fire” point 16 where the controllably positioned gun reaches the limit of its depression range and therefore the aiming line of the gun barrel is now above the target 26. Thus, the firing of the gun is automatically terminated. While not depicted here, in accordance with minimum flight level 29 restrictions of FIG. 1A the pilot will maintain higher minimum flight level while making the attack run to avoid various dangers from the ground. The aircraft 40 ascends to avoid the danger zone 28 “overflies target” 30, and “departs target” 32 while steeply ascending. The drawing clearly demonstrates that the flight segment during which the firing line of the barrel of the controllably positioned gun is suitably aligned with the target is the “effective projectile stream” 22 spanning point 14 through 16. The aircraft 40 could perform limited maneuvers during the firing zone in order to prevent precise tracking from the hostile A/A/A aiming and firing devices. When maneuvering the tracking devices of the aircraft 40 will be still locked on the target 26 and the gun will be positioned in accordance with the positioning calculations. In each relative point along the flight path with a similar range to the target the aircraft of the present invention with a flexible gun system is able to perform fire at a higher minimal flight level than the fixed gun. Such higher flight level is-depicted in FIG. 1B at the commence fire 14 point. The lower flight level can be seen in FIG. 1A at the commence fire 14 point which is relatively lower to the ground level.

Although the sizes of the objects, the altitudes, and the distances shown in the drawing are not according to scale, it should be noted that the attacking aircraft 10 is free to follow alternative flight paths and have a substantially longer period of time in which to align the firing line of the barrel of the fixed gun with the target 26. During the attack the aircraft 10 could fly in a line which is not straight, the necessity of low-level flight is negated and there is no substantial requirement to limit the speed of the attack as the “effective projective streams” 22 time window is long enough to send a reasonably sized projectile stream to the target 26 in order to achieve an effective hit thereon.

Danger from anti-aircraft fire and consequently workload on the attacking pilot is considerably reduced.

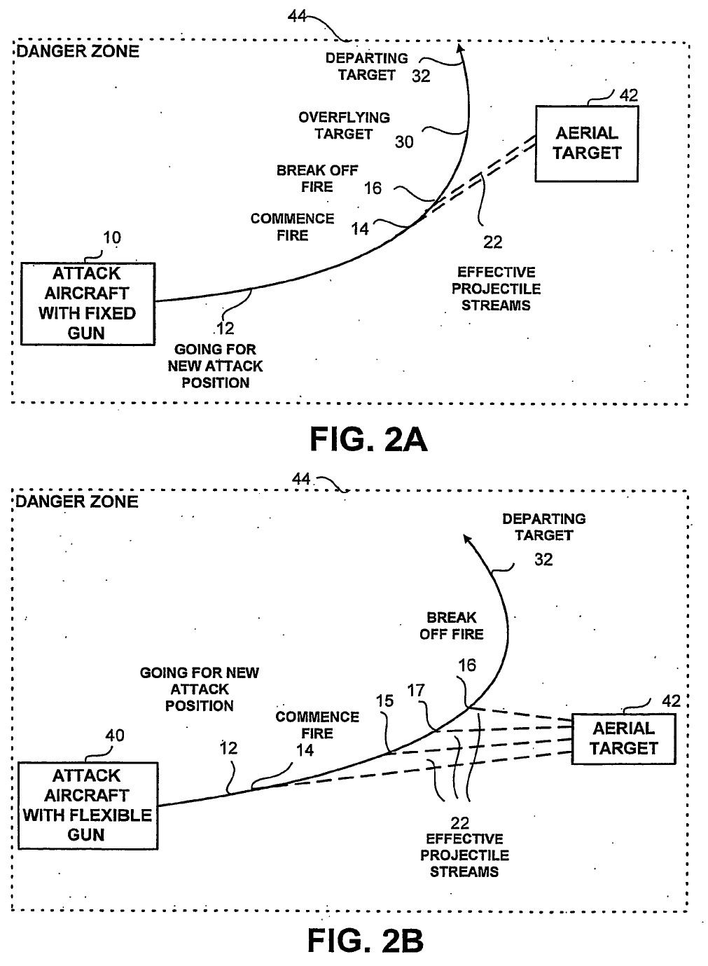

Referring to FIG. 2A that demonstrates an exemplary environment in which an aircraft 10 having a fixed gun system (not shown) is at the end of the interception run, performing an A/A gunnery firing against an aerial target 42, such as a hostile aircraft. The diagram is considerably simplified by showing a maneuver at substantially the same altitude during the engagement. Thus, the aircraft 10 and the target 42 maneuver in the horizontal plane only. The drawing provides a bird's eye view of the environment where the observer is looking down at the objects, movement paths, directions and critical points therein. For the clarity of the demonstration the aerial target 42 is shown as stationary though it would be easily perceived that in a realistic environment the aerial target 42 would maneuver in order to avoid the attack and/or attempting to put itself into an advantageous position for the initiation of a counter-attack. The aircraft 10 initial position shown is the position of the aircraft nearly at the end of the interception run where the aerial target 42 has not been hit by other weapons used by aircraft 10. The aircraft 10 will now maneuver to obtain a new position allowing the use of the various weapons available to the pilot of aircraft 10. The aircraft 10 will begin attempting to arrive at a new location in the point of the new maneuver 12. While making the maneuvering aircraft 10 may be passing the aerial target 42 along a curved flight path as shown. Such flight path may achieve an alignment of the aiming line of the barrel of the fixed gun mounted thereon with the target 42 at a specific point on the curve. At a specific “commence fire” point 14 the gun aiming point indicator in the gun sight of the aircraft 10 converges with the outline of the target 42. At this point the fixed gun of mounted on the aircraft 10 is activated and firing begins. The effective firing of the gun could continue as long as the outline of the target 42 is substantially overlaps the gun firing line indicator in the gun sight indicating that the firing line of the gun is aligned with the target 42. Thus between points 14 and 15 the gun could keep firing and “effective projectile streams” 22 could be sent in the direction of the target 42. At point 16 the attacking pilot breaks off the firing because it is not effective. Next the alignment between the gun aiming line and the outline of the target 42 in the gun sight is lost indicating that the gun firing line is not pointed to the target 42 any more. Thus the firing of the gun is terminated and the aircraft 10 over flies the target 30 and departs the target 32 on its way to a better attacking position.

Although the sizes of the objects, the altitudes, and the distances shown in the drawing are not according to scale, it should be noted that the aircraft 10 have a substantially limited period of time in which to align the firing line of the barrel of the fixed gun with the target 42. This is mainly because the firing run in A/A engagement is made when the attack aircraft 10 and the aerial target 42 pass each other on their way to a better attack position.

Referring to FIG. 2B that demonstrates an exemplary environment in which an aircraft 40 having a flexible (controllably positioned) gun system (not shown) is performing an A/A attack against an aerial target The aircraft 40 is approaches the aerial target 42 along a curved flight path. The curved path is chosen as a result of the pilot's attempt to obtain a better attack position at the end of the previous run, such as an interception run. The position shown is at the end of such interception run when both planes (the attack plane 10 and the aerial target 42) are fairly close (only about a few miles apart) and will maneuver to obtain a better attack position. Such an occurrence may occur, for example, near the end of an interception run when each aircraft has been trying to damage the other with the assistance of missiles and other like weapons. The engagement depicted by the drawing under discussion is extremely simplified by the generally unrealistic assumption that both aircraft 40 and aerial target 42 maneuvers at substantially the same altitude during the engagement. Thus, the aircraft 40 and the target 42 maneuver in the horizontal plane only. The drawing provides a bird's eye view of the environment where the observer is looking down at the objects, movement paths, directions and critical points therein. Furthermore, for the clarity of the demonstration the aerial target 42 is shown as stationary though it would be easily perceived that in a realistic environment the aerial target 42 would maneuver in order to avoid the attack and/or attempting to put itself into an advantageous position for the initiation of a counter-attack. The aircraft 40 is attempting to find a new attack position. The curve taken begins at position 12. While aircraft 40 attempts to maneuver itself to a new position approaches the aerial target 42 along a flexible curved flight path resulting in the alignment of the aiming line of the barrel of the adjustable gun mounted thereon with the target 42. At a specific “commence fire” point 14 the gun aiming point indicator in the gun sight of the aircraft 10 converges with the outline of the target 42. At this point the gun of the present invention mounted on the aircraft 40 is activated and firing begins. Firing is preferably automatic once the computer of the aircraft has acquired a target. Firing may also be performed manually. The effective firing of the gun could continue as long as the outline of the target 42 substantially overlaps the gun firing line indicator in the gun sight indicating that the firing line of the gun is aligned with the target 42. As the gun mounted on the aircraft 40 is provided the capability of continuously modifying its deflection between points 14 and 16 the gun could keep firing and “effective projectile streams” 22 could be sent in the direction of the target 42. At point 16 the firing is stopped because the angle will not allow hitting target 42. As a result, the alignment between the gun aiming line and the outline of the target 42 in the gun sight is lost indicting that the gun firing line cannot be pointed to the target 42 any more. Thus the firing of the gun is terminated and the aircraft 10 continues to “overfly the target” 30 and “departing the target” 32 on its way to establishing a new attack position. Point 16 when the fire is stopped can be determined automatically by the system of the present invention. When the target cannot be acquired or when there is likelihood the firing of projectiles will result in missing of the aerial target 42 the system will terminate the firing.

Although the sizes of the objects, the altitudes, and the distances shown in, the drawing are not according to scale, it should be noted that the aircraft 40 is free to follow alternative flight paths. During the attack the aircraft 40 could utilize alternative flight paths, the necessity of close approach the target is negated and there is no substantial requirement to limit the speed of the attack as the “effective projective streams” 22 time window is long enough to send a reasonably sized projectile stream to the target 26 in order to achieve an effective hit thereon. Due to the comparative unpredictability of the aircraft 40 flight path the pilot of the aerial target 42 will have a limited capability to estimate the course of action to be taken by the attacker and thus will have a lesser capability to perform successfully avoidance actions and counter attack maneuvers. Thus, the danger of a successful counter-attack and consequently the stress and the workload on the attacking pilot is considerably reduced. While, the examples shown in FIG. 2B, are the preferred embodiment of the present invention, persons skilled in the art will appreciate that the present invention is not limited to the end of the interception, buy take place as a direct attack on an opposing aerial target.

The comparison between the A/G attacks described on FIG. 1A and the A/A attacks described on FIG. 2A where the aircraft is armed with a fixed gun system with the A/G and A/A attacks described in association with FIG. 1B and 2B respectively where the aircraft is armed with a controllably positioned gun system clearly shows the superiority of the concept underlying the system and method proposed by the present invention. The controllably positioned gun system provides a plurality of alternate attack paths versus a substantially limited number of attack lines when using a fixed gun. The controllably positioned gun system allows the aircraft to avoid flying in close proximity to the target and enables performance of the attack at higher speeds. The combination of flexible attack lines, enhanced firing sectors, increased firing distances, and longer firing windows substantially contribute to the survivability of the aircraft.

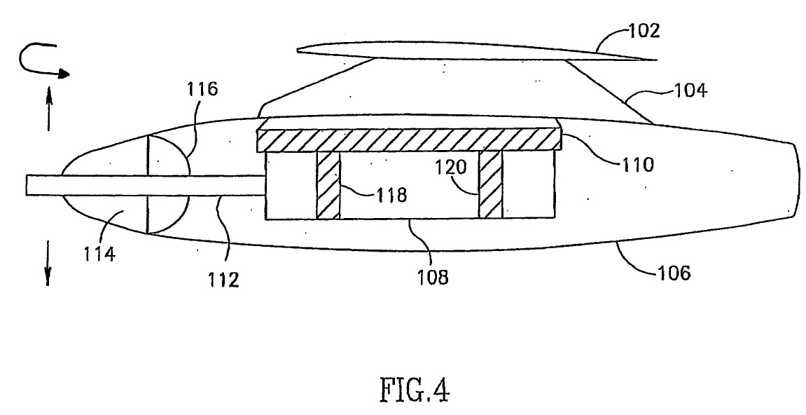

Reference is made now to FIG. 4 that provides a schematic simplified view of a gun pod 106 with an incorporated controllable movement gun 108, in accordance with the preferred embodiment of the present invention. The gun pod 106 is an aerodynamically efficient container attached to a carrier pylon 104, which, in turn is attached to the underside of a wing 102 of a fixed-wing aircraft (not shown). The gun pod 106 incorporates a gun 108 having an attached gun barrel 112. The gun 108 is mounted within the gun pod 106 through the utilization of a moveable gun mount system. The gun mount system includes a controllably moveable gun mounts base 110 and two or more gun mount devices 118, 120. The gun mount devices 118, 120 are fixedly connected to the controllably moveable gun mount base 110 on the one side and to the body of the gun 108 on the opposite side. The gun body 108 and the associated gun barrel 112 are disposed within the gun pod 106 such that the gun barrel 112 is physically projected from the gun pod into the air stream via a gun barrel opening 116 formed in the body of the gun pod 106. The gun barrel opening 116 is having a suitable substantially circular or elliptical shape in order to allow for appropriate freedom of movement for the gun barrel 112. The gun barrel opening 116 is equipped with a specifically designed, formed and attached flexible covering 114 to provide for the reduction of drag forces during the movement of the gun barrel 112 and to prevent the entry of the air stream into the interior of the gun pod 106. The gun may move in any direction on multiple axis.

Note should be taken that the above-described gun pod configuration is exemplary only. The incorporated gun could be attached to the pod via a variety of gun mounting means. The gun mount system could be configured in a different manner and the gun barrel opening and covering could be implemented in various alternative ways. 23.

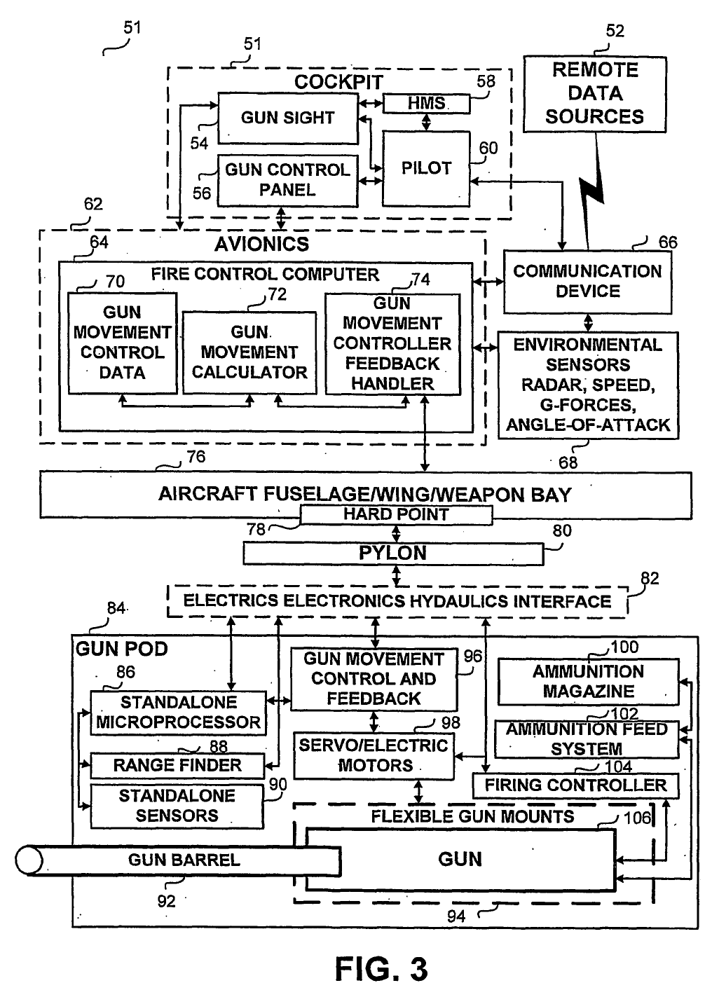

Referring now to FIG. 3 that shows an exemplary structure and the constituent components of the gun pod system, in accordance with the preferred embodiment of the present invention. The system 50 is installed on an aerial vehicle, such as a fixed-wing multi-role fighter aircraft, a UCAV, a light attack aircraft, a border patrol aircraft, a police aerial vehicle, and the like. The system 50 includes a gun pod 84 having an aerodynamic envelope to enclose the components installed therein. The gun pod 84 includes a gun 106 and associated one or more gun barrels 92 where the gun 94 is mounted on a set of flexible gun mounts 94. The gun 106 is fed ammunition by ammunition feed sub-system 102 where the rounds are fed into the feed sub-system 102 from one or more ammunition magazines 100. The magazine 100, the feed system 102 and a fire control sub-system 104 are rigidly mounted to the interior of the gun pod 84. The ammunition magazines 100 are replaceable and the gun 106, magazine 100, feed system 102, fire control system 104 are suitably maintained, such as ground tested via specific access panels installed in the envelope of the gun pod 84. In the preferred embodiment of the invention the gun is electrically controlled via a suitable electric interface assembly 82 between the gun pod 84 and a carrier pylon 80. The pod further includes conventional electronic control points, monitoring devices regarding the status of the gun 106 the number of rounds left in the magazine 100, and the like. The signals carrying the monitored data are transmitted via an electronic interface assembly 82 between the gun pod 84 to the carrier pylon 80 to be fed to an on-board fire control computer 64 and/or to a gun control panel display 56 in the cockpit 51 of the aircraft to be displayed to a pilot 60 either directly or via a helmet-mounted-display (HMD) 56 device. In order to fire the gun 106 the pilot 60 activates specific control components installed on the gun control panel 56 in the cockpit 51 affecting the transmission of specific control signals either to the on-board fire control computer 70 or directly to the gun pod 84. The gun 106 installed in the pod 84 could be any of the plurality of known guns having diverse calibers, such as 20-mm, 27-mm, or 30-mm, different rates of fire, such as 1,800, 4,000, or 6,000 rounds per minute (rpm), different number of barrels, such as single barrel gun, 3-barrel gun and 6-barrel gun, different operating principles and diverse advanced features. Some of the guns installed into the pod 84 could include the DEFA 30-mm cannon, the Mauser-Waffensystem 27-mm cannon, the General Electric M61A1 20-mm cannon, the GAU 2B/A 7.6-mm minigun, the XM214 5.56-mm minigun, the M195 20-mm gun, and the like. The gun 106 and its feed sub-system 102 could have advanced features such as selectable rate of fire, selectable type of projectiles, selectable burst length, linkless ammunition train, and the like.

In the preferred embodiment of the invention the gun 106 installed within the gun pod 84 is provided with the capability of being controllably positioned in the elevation and the azimuth relative to the axes of the aircraft. The degree of the movement of the gun (and consequently of the gun barrel) is a combination of one or two vectors. The gun barrel 92 can be positioned by being depressed or elevated in the vertical plane, and deflected in the directional plane. The sum of the one or two vectors provides the final aiming line of the barrel 92. The gun 106 can be controllably positioned dynamically and continuously either by manual instruction initiated by the pilot 60 from the cockpit 51 or by the salving of the gun to one or more sensor devices via a gun positioning control system, a fire control computer and a slaving software. The gun 106 is provided with a substantial range of movement both in the elevation and in the azimuth. In the preferred embodiment of the invention the range of displacement is about 25 degrees both in the elevation and in the azimuth. It should be easily perceived by one with ordinary skills in the art that in other preferred embodiments of the invention different repositioning range values could be used. The capability of controllably and dynamically positioning the gun 106 in the elevation and the azimuth provides considerable flexibility regarding the direction of the line of aim associated with the gun barrel 92. Thus, an aircraft carrying the gun pod 84 could be on the 50 degrees bearing while the gun barrel could point to the 70 degrees bearing. The gun positioning flexibility is extremely useful during aerial combat where a firing line to a target can be achieved by a combination of the dynamic maneuvering of the aircraft and the continuous manual or preferably automatic controlling of the elevation and/or azimuth of the gun barrel 92 by the slaving of the gun to one or more sensor devices via a firing computer, slaving software and gun movement control system.

The gun positioning control system could be installed across the aircraft in a pre-defined distributed manner or could be entirely integrated within the gun pod 84. In the preferred embodiment of the present invention an advanced aircraft is presented having a fire control computer, head-mounted-display, data-link capabilities and suitable environmental and weapon system sensors. The gun pod presented in the preferred embodiment includes standalone sensors, standalone-processing devices, and the like in order to be used as backup units in case of on-board units malfunctioning. In other preferred embodiments the gun pod 84 could include only those components necessary for the physical positioning of the gun 106 in accordance with control signals received from the aircraft cockpit 51 or aircraft avionics 62. In yet other preferred embodiments of the invention the pod 84 could include additional advanced components such as communication devices, data storage devices, and the like to make the gun pod 84 capable of operating independently even when mounted on aircraft with limited computing, data storage, and avionics capabilities (in that case D.L is a must). The pod 84 could operate in a manual mode, or a fully automatic mode when the mode selection is made by the pilot 60 utilizing specific mode-selector dials on the gun control panel 56 in the cockpit 51. The gun pod 84 could be slaved to the tracking sensors via the fire control computer 64, to the HMD 58, or to diverse remote data and control sources 52.

The combination of the acquisition/slaving devices and one or more processor devices may enable the uploading of the gun pod on an aircraft without an advanced avionics system or with a partial avionics suit. For example, the proposed system and method may be implemented on a small jet aircraft, such as the twin-engine Learjet 35A, having a sighting display with slaved designation indicators only. In this configuration the range finder may be installed in the carried gun pod located on the aiming line to the target and the integral computer may control the positioning of the gun barrel to the required direction.

Still referring to FIG. 3 the gun pod 84 includes a gun positioning control and feedback handler component 96, one or more servo/electric motors 98, a range finder device 88, a standalone microprocessor 86, and one or more standalone environmental and/or weapon system sensors. The gun positioning control and feedback control device 96 is responsible of receiving the control signals transmitted either from the fire control computer 70, the standalone in-pod microprocessor 86, the communication device 66, or the HMD 58. The device 96 decodes and interprets the received control signals and activates the servo/electric motors 98 in order to impart suitable movement to the flexible gun mounts 94 and thereby accomplishing the re-positioning of the gun barrel 92 respective to the aircraft such as to be pointed to the desired direction. The device 96 also handles the feedback signals received from the flexible gun mounts 106 regarding the status of the gun mounts 106 in order to further control the motors 98. The device 96 further feeds control signals regarding the position of the gun barrel 92 back to the fire control computer 64 and to the gun sight 54 and/or HMD 58 to update the position of the gun aiming point indicator in the gun sight 54 and/or the HMD 58. The motors 98 receive commands from the device 98 and respond by imparting movement in the elevation and/or the azimuth to the gun 106 via the flexible gun mounts 94. The motors 98 are either hydraulically or electrically actuated when the appropriate hydraulic lines and electrical lines supply hydraulic fluid and electrical power from the respective power generating systems in the aircraft via the carrier pylon 80 and the electrics/electronics/hydraulics assembly interface 82. The number of motors 98 could vary in accordance with the number, the size and the weight and of the gun 106 installed in the pod 84. The power output of the motors 98 could also vary in accordance with the mechanical arrangements associated with the flexible gun mounts 94. The motors 98 could supply dynamic feedback and status information to the device 96 concerning the current position of the gun mounts 94, possible mechanical and electric malfunctioning, system failures as a result of hits from hostile fire and the like.

Still referring to FIG. 3 the pod 84 is attached to a carrier pylon 80, which is mounted on a specific hard point 78 on the aircraft fuselage/underwing/internal weapon bay 76. The pylon 80 could be a standard stores carrier pylon suitably modified and strengthened or could be a completely re-designed novel pylon. The modifications could involve the insertion of additional power lines, hydraulic lines, data lines and the addition/modification of specific suspension hooks and stabilizer surfaces utilized to suspend the pod 84 on the pylon 80 and to hold the pod 84 firmly and rigidly in place. The aircraft could carry one or more gun pods 84 as replacements to one or more internally mounted fixed guns or as additions to the fixed guns. The gun pods 84 could be mounted as components of specific symmetrical or asymmetrical weapon configurations. The pods 84 could be uploaded in internal weapon bays when used by a stealth aircraft or could be mounted on the same externally consequent to a substantial suppression of the enemy defenses.

The gun positioning control system includes a fire computer 64, environmental sensors 68, data links 66, and gun standalone adjustment control components installed optionally in the gun pod 84. The gun positioning system further includes a gun control panel 56 and/or a head-mounted-display device 58 in the cockpit 51 of the aircraft. The gun control panel 56 includes gun pod activation switches, mode-selector switches displays and indicator lights. The firing of the gun 106 in the pod 84 is. accomplished by the activation of the gun trigger typically located on the aerodynamic control column (stick). The manual positioning of the gun 106 is typically achieved by the activation of a specific multi-directional control stick having a 360 degrees movement range by the pilot or by a Weapon Systems Officer.

The fire control computer 64 includes a gun positioning control data file 70, a gun movement calculator device 72 (which could be both a hardware or a software implemented device), and a gun movement controller and feedback handler 74. The fire control computer (FCC) 64 is typically receives, decodes, interprets and processes analog and digital data, control signals, commands in order to handle the weapon systems of an aircraft in an integral manner. It would be easily understood that the FCC 64 handles and control other weapon system in addition to the adjustable gun pod 84 and thus the drawing under discussion presents only a partial set of devices, files, and routines operative in the FCC 64.

The gun movement control data file 70 stores the static data concerning the specific flight envelope of the aircraft and: the characteristics of the gun 106. The data file 70 further stores test flight data collected during flight tests performed when the gun pod 84 was a component of one or more weapon configuration. The tests are performed under a variety of flight conditions involving A/G attacks, A/A engagements with the gun pod active and firing in the manual, automatic or semi-automatic mode. The operative behavior of the gun pod 84 and the gun 92 in combat simulations involving a variety of flight patterns in analyzed and the results of the analysis is stored in the file 70. Optionally the file 70 could store data regarding the characteristics of a ground target or the relevant flight and weapon data of an aerial target for display to the pilot or to the Weapon Systems Officer. In addition to the static data in the file 70 the FCC 64 is fed by dynamic AOA, speed, and other like data collected by specific sensors, such as a radar or other search/detect/lock device, speed sensors, G sensors, angle-of-attack sensor s and the like or received from ground stations.

Additional dynamic data regarding both the aircraft the target and the relative position there between could be fed to the FCC via a high-speed wideband data link, such as the MAXBUS from remote data sources 52, such as airborne or ground based command and control platforms, satellites, flight leaders, support aircraft, and the like and an in-board communication device such as a high-speed modem or network interface card. The static data, the locally generated dynamic sensor data, the remotely generated dynamic data, and the control signals from the gun pods 84 are collated, integrated and processed by the gun movement calculator 72. The deflection calculation is preferably performed by the FCC, which also performs the firing computations for other aircraft systems and weapon systems and integrates the data in its position with data relating to the detection and locking on enemy targets. The FCC will thus be able to both detect, integrate the various information available to lock on the target and make the necessary calculations to adjust the direction of the gun of the present invention.

The results of the processing indicate the direction and degree of the necessary movement of the gun 106 within the gun pod 84. The requisite control signals generated by the calculator 72 are fed to the gun movement controller and feedback handler that transmits the signals via suitable data links to the gun pod 84. The signals affect the actuation of the gun movement motors 98 that position the gun barrel 92 such that it preferably aligns with the target. Feedback signals from the gun 106 and the motors 98 are forwarded from the pod 84 to the FCC 64 in order to be processed by the handler 74. The gun movement controller and feedback controller 74 stores at all times the current operative position of the gun barrel 92 in order to provide to the gun movement controller 72 up-to-date weapon situational information concerning the gun 106. The FCC 64 further controls the movement of the gun aiming line indicator in the gun sight 54 and/or the HMS 58 to provide visual information to the pilot 60 concerning the appropriate ACM to be performed in order to reach an advantageous position in the combat.

The present invention regards an aerial gun that is provided with the capability of being controllably and dynamically positioned in the elevation and azimuth while being installed in a gun pod mounted on a fixed-wing aerial combat vehicle performing high-speed maneuvers. The concepts of the invention having novelty are detailed in the following list either separately or in suitable combinations: a) the gun pod mounted on a fixed-wing aerial combat vehicle and having an aerodynamic envelope carries an existing or prospective aerial gun, b) the internal and external structure, configuration, diameter and volume of the gun pod allows for the controllable movement of the gun therein in the elevation and the azimuth, c) the controllable movement of the gun mounted inside the gun pod is enabled by imparting movement to suitably mounted flexible gun supports via actuator devices, such as hydraulic or electric powered motors integrally installed in the pod, d) in accordance with the flight envelope of the aircraft (maximum speed, operational altitude, allowable G-force, auxiliary carriage, etc.) the gun pod is designed such as to being able to support the resulting loads, e) the range of the controllable movement in the elevation and the azimuth provided to the gun is determined in accordance with the data such as internal and external structure, diameter and the volume of the gun pod, and overall configuration considerations, ?d) the gun pod is having a minimum impact on the aerodynamic efficiency, stability and optimal maneuvering capability of the aircraft (maximum movement versus minimum necessary aircraft drag increase and stability redaction), f) the gun pod is rigidly and fixedly mounted on the aircraft and have a minimal positioning capability in order not to impact negatively the aerodynamic efficiency, stability and handling characteristics of the aerial combat vehicle, g) in order to enable the firing of the gun in a deflected firing sector suitable ranges of movement both in the elevation and the azimuth are provided to the gun barrel. Thus, a gun pod aperture (either in the fore or the rear of the gun pod according to the orientation of the gun) is provided where the gun pod aperture is having a suitably extended diameter and non-rigid aerodynamic covering means that extends flexibly between the circumference of the gun barrel aperture and the external part of the gun barrel in order to prevent entry of the air stream into the gun pod and thereby maintain the efficiency of the air flow in the vicinity of the gun pod, h) the range of movement provided to the gun barrel may determined by the type of the aircraft, the weapon configuration of the aircraft, the specific configuration of the gun pod and the type of the gun mounted therein. Thus, it is conceivable that a particular gun type A installed in a gun pod will have a more limited range of movement that a specific gun type B installed in the same gun pod, I) the ranges of movement associated with the elevation and the azimuth could differ. Therefore, the gun barrel could be positioned such as to provide a circular deflection firing sector, a'spherical deflection firing sector, or the like, j) for the performance of an A/A mission the gun pod will be mounted preferably on a center fuselage hard point while for an A/G mission diverse other hard points could be used, and one or more gun pods could be carried within a combined weapon configuration of the aerial combat vehicle, k) the type of the mission planned and therefore the location of the hard point on which the pod is mounted could be factors in determining the ranges of movement provided to the gun in the elevation and/or the azimuth, 1) optionally, the ranges of movement provided to the gun could be dynamically determined and modified in the elevation and/or in the azimuth.

Note should be taken that the gun pod 84 could be converted to the carriage of other weapon systems and support systems, such as grenade launchers, PGM, advanced missiles, electronic counter measures, laser designators, and the like while utilizing the novel basic concepts underlying the present invention.

The allowable positioning limits of the gun in both axes of the movement could be pre-defined. Optionally a dynamic control of the positioning limits could be implemented via suitable calculations performed within the on-board fire control computer or within the independent in-pod microprocessor. The calculated limits will be derived from real-time information, such as air speed, angle of attack, outside air pressure, and the like. The results of the calculations could be also a function of data collected and collated during flight tests that include the optimized combination of maximum gun positioning limits versus the aerodynamic efficiency and stability of the platform. The positioning limits could further depend on the flight envelope, maneuver, altitude, roll, pitch, yaw and the like. All the relevant data will be stored in the on-board fire control computer or in the in-pod microprocessor and will define dynamically in real time the limits of the positioning. Furthermore, the positioning envelope in both axes could be further derived from the characteristics of the aerial vehicle, the gun podi the gun installed in the pod, the location of the pod within an external configuration (weapon station) and the like.

The barrel of the gun will be pointed to a forward looking, a backward looking or any other angular firing section in accordance with the design limitations, the operational requirements, the physical size of the pod and the gun therein, the physical limitations concerning the movement of the gun within the pod, and the like, while maintaining acceptable aerodynamic characteristics of the aerial vehicle.

The barrel of the gun will be deflected automatically to a firing line that will enable the hitting of either a stationary or a maneuvering target. In order to accomplish this objective either a specifically designed and developed software application would developed or existing software application will be substantially upgraded.

The other conceptual characteristics of the proposed system and method such as the utilization of target acquisition sub-systems, manual or automatic target locking (via radar, FLIR, IR, Data Link), helmet-mounted sight targeting systems, high precision location of targets via communication systems/aerial vehicle weapon control system are know in the art and are installed on a variety of vehicles in diverse combinations. These advanced fire control systems and weapon-positioning systems reached maturity years ago and today they are standard equipment in combat helicopters. The principal novelty of the present invention is the implementation of a combination of the above sub-systems as aerial gunnery support components on fixed-wing aerial combat vehicles and the performance of suitable upgrades responding to the particular operational demands involved in the utilization of the system and method proposed on high-speed, high-performance, aerodynamically efficient aerial vehicles operating within strictly pre-defined flight envelops.

It will be appreciated by persons skilled in the art that the present invention is not limited to what has been particularly shown and described hereinabove. Rather the scope of the present invention is defined only by the claims, which follow.

I claim:

1. An apparatus for dynamically controlling the elevation and azimuth of an aerial gun incorporated within a gun pod mountable on a fixed-wing aerial-combat vehicle, the apparatus comprising the elements of:
at least one aerodynamically gun pod unit for storing, delivering, controlling and supporting at least one controllable elevation and azimuth movement aerial gun unit;
at least one controllable movement aerial gun unit mounted in the at least one aerodynamically efficient gun pod unit and designed for the delivery of suitable gun projectile units to a/target.

2. The apparatus as claimed in claim 1 further comprises a gun movement control device to effect controllably the movement of the at least one aerial gun unit.

3. The apparatus as claimed in claim 1 wherein the at least one aerodynamically efficient gun pod unit comprises the elements of:
at least one actuator device to respond to control signals transmitted by the gun movement control means and impart movement to at least one gun mount device;
at least one moveable gun mount device to support the controllable movement aerial gun unit and effect the movement of the aerial gun unit in accordance with the control signals received from the gun movement control means;
an extended gun pod aperture to provide suitable gun barrel movement volume to the at least one aerial gun unit;
a gun pod aperture covering to prevent ingress of the air stream into the at least one gun pod unit and to maintain efficient airflow in the vicinity of the at least one gun pod unit.

4. The apparatus as claimed in claim 3 wherein the at least one gun pod unit is provided with suitable internal and external structure, component configuration, diameter and volume to allow for the controllable movement of the at least one aerial gun unit.

5. The apparatus as claimed in claim 3 wherein the at least one gun pod unit is capable of supporting the loads resulting from the high-speed, high-performance maneuvering of the fixed-wing aerial combat vehicle involving substantial G forces in accordance with the pre-determined flight envelope of the vehicle.

6. The apparatus as claimed in claim 3 wherein the internal and external structure, component configuration, diameter and volume of the at least one gun pod unit are factors in determining the ranges of the controllable movement provided for the at least one aerial gun unit.

7. The apparatus as claimed in claim 3 wherein the at least one gun pod unit is having a minimal impact on the aerodynamic efficiency, stability and handling characteristics of the fixed-wing aerial combat vehicle.

8. The apparatus as claimed in claim 1 wherein the at least one gun pod unit is preferably mounted on center fuselage hard point.

9. The apparatus as claimed in claim 8 wherein the at least one gun pod unit is mountable on diversely located hard points.

10. The apparatus as claimed in claim 1 wherein the at least one gun pod unit is an element in the weapon configuration of the fixed-wing aerial combat vehicle.

11. The apparatus as claimed in claim 1 wherein the at least one controllable movement aerial gun unit is provided with an allowable range of controllable movement in the elevation and in the azimuth.

12. The apparatus as claimed in claim 1 1 wherein the allowable ranges of movement in the elevation and the azimuth are determined by the type of aerial vehicle, by the weapon configuration of the aerial vehicle, by the flight envelope of the vehicle, by the characteristics of the at least one gun pod unit, by the characteristics of the at least one aerial gun unit and by the location of the hard point whereon the at least one gun point unit is mounted.

13. The apparatus as claimed in claim 1 1 wherein the allowable ranges of movement in the elevation and azimuth are determined and modified dynamically in-flight in accordance with the position of the aerial vehicle in relation to the vehicle's flight envelope, load factor, outside air pressure and the maneuver's envelope.

14. The apparatus as claimed in claim 1 1 wherein the allowable range of movement in the elevation and the azimuth for the at least one aerial gun unit are pre-determined.

15. The apparatus as claimed in claim 11 wherein the allowable range of movement in the elevation and in the azimuth are dynamically determined and modified in-flight.

16. The apparatus as claimed in claim 1 wherein the fixed-wing aerial combat vehicle is an attack, trainer, A/A or a multi-role military aircraft.

17. The apparatus as claimed in claim 1 wherein the fixed-wing aerial combat aircraft is an unmanned combat aerial vehicle.

18. The apparatus as claimed in claim 1 wherein the at least one gun pod unit is fixedly mounted on the fixed-wing aerial combat vehicle.

19. The apparatus as claimed in claim 1 wherein the at least one gun pod unit mounted on the fixed-wing aerial combat vehicle has a minimal controllable movement capability.

20. The apparatus as claimed in claim 3 wherein the at least one gun pod unit provides storage, delivery, control and support functions for precision-guided munitions. OK

21. The apparatus as claimed in claim 19 wherein the at least one gun pod unit provides storage, delivery, control and support functions for electronic countermeasure devices.

22. The apparatus as claimed in claim 3 wherein the at least one gun pod unit further comprises the elements of:
at least one range finder device to measure continuously the range between the gun pod unit and a target during an aerial engagement;
at least one processor device to perform gun movement and aiming control calculations;
at least one sensor device to capture environmental and weapon data;
at least one gun movement control and feedback device to receive control signals from the gun movement control means, activate the gun mount actuators and handle feedback information from the gun mount devices, and gun mount actuators.

23. The apparatus as claimed in claim 1 wherein the at least one aerial gun unit is a M61A1 20-mm gun.

24. The apparatus as claimed in claim 22 wherein the at least one aerial gun unit is a DEFA 30-mm gun.

25. The apparatus as claimed in claim 11 wherein the allowable angle of movement in the elevation is about between 5 degrees to about 70 degrees.

26. The apparatus as claimed in claim 11 wherein the allowable range of movement in the azimuth is about between 5 degrees to about 70 degrees.

27. The apparatus as claimed in claim 11 wherein the allowable angle of movement in the elevation is about between 5 degrees to about 70 degrees.

28. The apparatus as claimed in claim 11 wherein the allowable range of movement in the azimuth is about between 5 degrees to about 70 degrees.

29. The apparatus as claimed in claim 3 wherein the at least one gun pod unit is a suitably modified existing gun pod unit.

30. The apparatus as claimed in calm 29 wherein the at least one gun pod unit is a novel, specifically designed, developed, tested and certified gun pod unit

31. A method for dynamically controlling the elevation and azimuth of at least one aerial gun unit incorporated within at least one gun pod unit mountable on a fixed-wing aerial combat vehicle, the method comprising the steps of:
modifying the strength, diameter and volume of the at least one gun pod unit to allow for the incorporation of the at least one gun unit and gun movement support components;
extending the diameter of the gun pod aperture to enable the allowable ranges of movement in the elevation and the azimuth for the barrels associated with the at least one gun unit;
installing an aerodynamic flexible covering on the gun pod aperture to provide for efficient airflow in the vicinity of the gun pod unit.

32. The method as claimed in claim 31 further comprises the steps of:
inserting at least one flexible gun unit mount device within the at least one gun pod unit for the transmission of movement to the at least one gun unit;
installing at least one actuator devices within the at least one gun pod unit to impart movement to the at least one flexible gun mount devices;
installing at least one range finder device within the at least one gun pod unit to provide for measuring range between the gun pod unit and the target;
installing at least one processor device in the at least one gun pod unit to provide for gun movement value calculations;
installing at least one sensor device in the at least one gun pod unit for dynamically capturing environmental and weaponry data.

33. The method as claimed in claim 31 further comprises the steps of:
determining the flight envelope of the fixed-wing aerial combat vehicle while the fixed-wind aerial combat vehicle carries at least one gun pod units, controllably positioning the at least one gun unit incorporated therein across the allowable ranges of movement in the elevation and in the azimuth and firing the at least one
gun unit across the allowable range of movements in the elevation and in the azimuth;
storing the flight envelope data within an on-board fire control computer in the fixed-wing aerial combat vehicle;
storing the flight envelope data within at least one processor device installed in the at least one gun pod unit.

34. The method as claimed in claim 31 further comprises the step of slaving the at least one controllably movable gun unit incorporated in the at least one gun pod unit to at least one onboard sensor devices. The method as claimed in claim 30 further comprises the step of manually aiming the moveable gun unit based on raw data provided to the pilot.

35. The method as claimed in claim 31 further comprises the step of slaving the at least one controllably moveable gun unit incorporated in the at least one gun pod to at least one in-pod sensor devices.

36. An apparatus for dynamically controlling the elevation and azimuth of at least one aerial gun unit incorporated within at least one gun pod unit mountable on a fixed-wing aerial combat vehicle, the system comprising the elements of:
at least one onboard fire control computer to store gun movement control data, to receive sensor data, to receive remote data, to calculate and generate gun movement, to communicate with the vehicle's operating crew and to communicate with the at least one gun pod unit;
at least one onboard sensor device to collect relevant environmental information, and to transmit the information to the at least one fire control computer;
at least one onboard communication device to communicate with at least one remote information source and to transmit the received information to the at least one fire control computer;
at least one aerodynamically efficient gun pod unit for storing, delivering, controlling and supporting at least one controllable elevation and azimuth movement aerial gun unit;
at least one controllable movement aerial gun unit mounted in the at least one aerodynamically efficient gun pod unit and designed for the delivery of suitable gun projectile units to a ground-based or aerial target.

37. The apparatus as claimed in claim 36 wherein the at least one onboard fire control computer comprises the elements of:
at least one gun movement control data structure to store gun movement limitation data, aerial vehicles flight envelope data, and weapon system envelope data;
a gun movement calculator to calculate the optimal gun movement values based on the gun movement control data to obtain a deflection resulting in hitting the target;
a gun movement controller and feedback handler to transmit gun movement commands to the gun pod, to receive gun movement and status feedback from the gun pod and to transmit gun movement and status feedback data to the gun movement calculator.

38. The apparatus as claimed in claim 36 wherein the at least one gun pod unit comprises the elements of:
a gun movement controller and feedback handle to transmit gun movement control commands to the gun movement actuators and to receive status information from the actuators;
at least one gun movement actuator to effect the movement of the flexible gun mounts.

39. The apparatus as claimed in claim 36 wherein the at least one gun pod unit further comprises at least one standalone microprocessor.

40. The apparatus of claimed in claim 36 wherein the at least one gun pod further comprise at least one range finder device.

41. The apparatus as claimed in claim 36 wherein the at least one gun pod unit further comprises at least one stand-alone sensor device.
